(19) United States
(12) Patent Application Publication
(10) Pub. No.: US 2016/0211512 A1
(43) Pub. Date: Jul. 21, 2016

(54) NEGATIVE-ELECTRODE ACTIVE MATERIAL AND ELECTRIC STORAGE APPARATUS

(71) Applicant: KABUSHIKI KAISHA TOYOTA JIDOSHOKKI, Kariya-shi, Aichi (JP)

(72) Inventors: Yusuke SUGIYAMA, Kariya-shi (JP); Masataka NAKANISHI, Kariya-shi (JP); Nobuhiro GODA, Kariya-shi (JP); Masakazu MURASE, Kariya-shi (JP); Hiromitsu TANAKA, Nagakute-shi (JP); Hirotaka OKAMOTO, Nagakute-shi (JP)

(73) Assignee: KABUSHIKI KAISHA TOYOTA JIDOSHOKKI, Kariya-shi, Aichi (JP)

(21) Appl. No.: 15/024,252

(22) PCT Filed: Aug. 8, 2014
(86) PCT No.: PCT/JP2014/004138

§ 371 Date: Mar. 23, 2016

(30) Foreign Application Priority Data
Sep. 24, 2013 (JP) 2013-196605

(51) Int. Cl. H01M 4/36; H01G 11/42; H01G 11/32; H01M 4/62; H01G 11/38; H01M 10/0525; H01M 4/587; H01M 4/133; H01G 11/50; H01G 11/68

(52) U.S. Cl. CPC H01M 4/364; H01G 11/50; H01G 11/42; H01G 11/32; H01G 11/68; H01G 11/38; H01M 10/0525; H01M 4/587; H01M 4/133; H01M 4/622; H01M 2004/027

(57) ABSTRACT

A negative-electrode active material includes a mixed power of a first active-material powder composed of a granular graphite particle, and a second active-material powder composed of a plate-shaped graphite particle having a thickness of from 0.3 nm to 100 nm and a major-axis-direction length of from 0.1 μm to 500 μm. Since the plate-shaped graphite particle has a lam liar structure, the plate-shaped graphite particle excels in the strength and flexibility, and function as a negative-electrode active material because lithium ions come in and out between the layers. Therefore, while securing the flexibility of negative-electrode active-material layer, the contradictory event between the capacity and the conductive property is solved.

### TECHNICAL FIELD

The present invention relates to a negative-electrode active material used for electric storage apparatuses such as lithium-ion secondary batteries, and to an electric storage apparatus such as secondary batteries, electric double-layer capacitors and lithium-ion capacitors using the negative-electrode active material, respectively.

### BACKGROUND ART

Lithium-ion secondary batteries have high charged and discharged capacities, and are batteries being able to make the outputs high. Currently, the lithium-ion secondary batteries have been used mainly as power sources for portable electronic appliances, and have further been expected as power sources for electric automobiles anticipated becoming widespread from now on.

As for a positive-electrode active material used for the lithium-ion secondary batteries, metallic oxide-based compounds represented by lithium cobaltate of which the charged and discharged capacities per unit mass are high at high potential have been employed. As for a negative-electrode active material, carbon materials represent by graphite of which the charged and discharged capacities are large at low potential close to the potential of lithium (Li) have been used.

For example, as for the negative-electrode active material, the following have been used so far: natural graphite, artificial graphite, low-crystalline carbon materials, amorphous carbon materials, surface-coated carbon materials, mesophase pitch-based carbon fibers, and carbon materials doped with heterogeneous species such as boron. Among the above, attention has been paid to natural graphite because a high battery capacity is obtainable. However, since the decomposition reaction of electrolytic solution is violent, the natural graphite has such a problem that the cyclic longevity is short; and accordingly putting the natural graphite into practical application has been difficult.

Meanwhile, since artificial graphite, which is obtainable by heat treating coke, or the like, serving as a raw material, has satisfactory cyclability comparatively, the artificial graphite has been employed widely as a negative-electrode active material at present. And, in order to further upgrade the capacities and cyclability, developments of the negative-electrode active material have been investigated actively even at present. For example, the following have been investigated: granular graphite, which is granulated, or is processed into a spherical shape, by carrying out a mechanical treatment onto a graphitic material with high crystallinity; and treated graphite with a surface, which is covered with pitch or resin and is subjected to a heat treatment, in order to suppress the superficial reactivity of negative-electrode active material.

Moreover, adding to a negative electrode a conductive additive, such as carbon black, graphite fine powders, carbon fibers and gas-phase-method carbon fibers, is effective in order to maintain or upgrade the conductive property between the respective negative-electrode active materials. In particular, since the gas-phase-method carbon fibers are minute Fibrous materials, the gas-phase-method carbon fibers are effective in forming conductive paths between the active materials. Since the gas-phase-method carbon fibers enable to make the electric resistance of electrode smaller when a large current is flowed, the gas-phase-method carbon fibers have been believed to be advantageous for taking out large energy. Moreover, as to the charge/discharge cyclic longevity, since the configuration is still a fibrous shape even when the expansions and contractions of the active materials themselves have occurred, maintaining the conductive paths are believed to be possible. Consequently, investigating the gas-phase-method carbon fibers has been also carried out from a viewpoint of improving the cyclic longevity.

For example, in Japanese Unexamined Patent. Publication (KOKAI) Gazette No. 2000-133267 (i.e., Patent Application Publication No. 1), cyclability is upgraded by adding gas-phase-method carbon fibers in an amount of from 0.5 to 22.5 parts by mass with respect to scale-shaped graphite or sphere-shaped graphite serving as negative-electrode active material. However, when the gas-phase-method carbon fibers are localized, since current has concentrated in the secondary particles so that only the parts deteriorate concentratedly, the cyclability has been upgraded insufficiently.

Hence, in Japanese Unexamined Patent Publication. (KOKAI) Gazette No. 2005-019399 (i.e., Patent Application Publication No 2), a negative-electrode material for lithium-ion secondary battery is proposed, the negative-electrode material characterized in that a fiber-shaped graphite material “B” is adhered onto a granulated graphitic material “C” composed of scale-shaped graphite by an adhesion agent “A” composed of a carbonaceous material and/or graphitic material with low crystallinity. By thus adding the fiber-shaped graphite material ensuring flexibility and the amorphous carbon to the granulated graphitic material, the lithium-ion input and output characteristics are improved. Accordingly, a lithium-ion secondary battery fabricated using the negative electrode exhibits high fast-rate charging/discharging efficiencies, excels also in the initial charging/discharging efficiency and cyclability, and not only excels in the discharged capacity as well but also the production cost of the negative-electrode material itself is low.

Moreover, in Japanese Unexamined Patent Publication (KOKAI) Gazette No. 2007-042620 (i.e., Patent Application Publication No. 3), a negative electrode for lithium-ion secondary battery is proposed, negative electrode in which natural graphite or artificial graphite is employed for a negative-electrode active material, and negative electrode in which carbon fibers excelling in the conductive property are dispersed uniformly in a concentration of from 0.1 to 10% by mass hin the negative electrode without forming any agglomerates having a size of 10 μm or more. A lithium-ion secondary battery provided with the negative electrode exhibits a long cyclic longevity, and excels in the large-current characteristic.

However, since carbon fibers function as conductive additive mainly, the greater the addition amount becomes the more the graphite concentration decreases relatively, though the conductivity upgrades, and the operational potential of a negative electrode has risen. Accordingly, there has been such a problem that the capacity declines as a battery cell in total.

### Patent Literature

Patent Application Publication. No. 1: Japanese Unexamined Patent Publication (KOKAI) Gazette No. 2000-133267;

Patent Application Publication No. 2: Japanese Unexamined Patent Publication (KOKAI) Gazette No. 2005-019399; and

Patent Application Publication No. 3: Japanese Unexamined Patent Publication (KOKAI) Gazette No. 2007-042620

### SUMMARY OF THE INVENTION

### Technical Problem

The present invention is made in view of the circumstances mentioned above. An object to be solved is solving the contradictory event between the capacity and conductive property of negative-electrode active-material layer while securing the flexibility.

### Solution to Problem

Features of a negative-electrode active material according to the present invention solving the aforementioned object lie in that the negative-electrode active material comprises a mixed powder including;
a first active-material powder composed of a granular graphite particle; and
second active-material powder composed of a plate-shaped graphite particle having a thickness of from 0.3 nm to 100 nm and a major-axis-direction length of from 0.1 μm to 500 μm.

### Advantageous Effects of the Invention

In the present invention, the first active-material powder, and the second active-material powder composed of the plate-shaped graphite particle are mixed to make a negative-electrode active material. The plate-shaped graphite particle has a lamellar structure in which multiple pieces of a graphene single layer are laminated, and functions a negative-electrode active material because lithium ions, and the like, are retained between the layers. Moreover, since the plate-shaped graphite particle has a lamellar structure, the plate-shaped graphite particle excels in the strength and flexibility. Therefore, mixing the plate-shaped graphite particle leads to relaxing stresses acting on a negative-electrode active-material layer at the time of charging and discharging operations, and accordingly resulting in upgrading the cyclability of an electric storage apparatus. Moreover, since the plate-shaped graphite particle also has a high conductive property, mixing the plate-shaped graphite particle leads to upgrading an ionic conductive property.

In addition, an aromatic vinyl copolymer, which contains a vinyl aromatic monomer expressed by following formula (1), is preferably adsorbed onto a surface of the plate-shaped graphite particle:

—(CH₂—CHX)— (1)

(in formula (1), “X” represents a phenyl group, naphtyl group, an anthracenyl group or a pyrenyl group, wherein the groups are also allowed to have a substituent group).

Since the flexibility and affinity with a binder are upgraded by the thus adsorbed polymer, the advantages mentioned above are effected more greatly. Accordingly, intending to make capacities high is also possible by reducing an amount of the binder.

### BRIEF DESCRIPTION OF THE DRAWINGS

FIG. 1 is an electron microscope photograph of a cross-sectional structure of a negative electrode formed in a first example;

FIG. 2 is an electron microscope photograph of a cross-sectional structure of a negative electrode formed in a first comparative example;

FIG. 3 is an electron microscope photograph of a cross-sectional structure of a negative electrode formed in a second comparative example;

FIG. 4 is a graph showing charging curves at 0.3 C;

FIG. 5 is a graph showing rate efficiencies in respective rates; and

FIG. 6 is a graph showing charging curves at 1 C.

### DESCRIPTION OF THE EMBODIMENTS

### First Active-Material Powder

The first active-material powder is composed granular graphite particles. Accordingly, using natural graphite, artificial graphite, scale-shaped graphite, sphere-shaped graphite, granulated graphite, hard carbon, soft carbon, or the like, is possible. A preferable average particle diameter D₅₀ of the granular graphite particles is from 300 nm or more to 20 μm or less. When an average diameter D₅₀ of the first active-material powder is less than 300 nm, a specific surface area of the first negative-electrode active-material powder becomes so large that the contact area enlarges between a powder of the first negative-electrode active material and an electrolytic solution. Accordingly, the decomposition of an electrolytic solution has proceeded, so that the cyclability worsens. Moreover, having average particle diameter D₅₀ of less than 300 nm is not preferable, because the secondary particle diameter becomes large by agglomeration.

Measuring the average particle diameter D50 is possible by a grain-size distribution measurement method. The “average particle diameter D₅₀” designates a particle diameter at which an accumulated value of volumetric distributions in a grain-size distribution by laser diffractometry corresponds to 50%. That is, the “average particle diameter D₅₀” designates a median diameter measured on a volumetric basis. A crystallite size is computed by the Scherrer equation from the half-value width of a diffraction peak obtained by an X-ray diffraction (or XRD) measurement.

### Second Active-material Powder

The second active-material powder is composed of plate-shaped graphite particles having a thickness of from 0.3 nm to 100 nm and a major-axis-direction length of from 0.1 μm to 500 μm. The plate-shaped graphite particles are obtained, for instance, by pulverizing publicly-known graphite (to be concrete, artificial graphite, scale-shaped graphite, massive graphite, earthy graphite, or the like) having a graphitic structure lest the graphitic structure is not destructed. Moreover, as the plate-shaped graphite particles, using commercially available graphene is possible.

The plate-shaped graphite particles have a considerably small thickness, respectively, even compared with the scale-shaped graphite, namely, natural graphite. An aspect ratio of the plate-shaped graphite particles, found by “(the major-axis-direction length)/(the thickness),” is from 10 to 1,000, or a more desirable aspect ratio is from 50 to 100.

A thickness of the plate-shaped graphite particles is from 0.3 nm to 100 nm, or a more preferable thickness is from 1 nm to 100 nm. A major-axis-direction length of the plate-shaped graphite particles is from 0.1 μm to 500 μm, or a more preferable major-axis-direction length is from 1 μm to 500 μm. A preferable minor-axis-direction length is from 0.3 μm to 100 μm.

Onto a surface of the plate-shaped graphite particles, bonding a functional group, such as a hydroxyl group, a carboxyl group or an epoxy group, is preferable. By bonding the functional group onto a surface of the plate-shaped graphite particles, the affinity is increased between the plate-shaped graphite particles and other organic substances, such as a solvent or polymer.

Such a functional group is preferably bonded to 50% or less of all carbon atoms present in the vicinity of a surface of the plate-shaped graphite particles, favorably in a region from the surface down to the 10-nm depth; is more preferably bonded to 20% or less of the carbon atoms; or is especially preferably bonded to 10% or less thereof. Moreover, a preferable proportion of the carbon atoms with which the functional group is bonded is 0.01% or more. When the proportion of the carbon atoms with which the function group is bonded exceeds 50%, a hydrophilic property of the plate-shaped graphite particles augments. Accordingly, the affinity of the plate-shaped graphite particles to the organic substances tends to decline. Note that an X-ray photoelectron spectroscopy (or XPS) enables to quantitatively determine the functional group in the vicinity of a surface of the plate-shaped graphite particles.

Moreover, onto a surface of the plate-shaped graphite particles, an aromatic vinyl copolymer is bonded preferably, the aromatic vinyl copolymer containing a vinyl aromatic monomer unit expressed by following formula (I):

—(CH₂—CHX)— (1)

(in formula (1), “X” represents a phenyl group, a naphtyl group, an anthracenyl group or a pyrenyl group, wherein the groups are also allowed to have a substituent group).

When the aromatic vinyl copolymer is adsorbed onto a surface of the plate-shaped graphite particles, a cohesive force between the respective plate-shaped graphite particles declines. Moreover, since the affinity between the plate-shaped graphite particles and a solvent or polymer increases, dispersing the plate-shaped graphite particles satisfactorily within the solvent, or within the polymer, is possible. When enabling the plate-shaped graphite particles to be highly dispersed within the solvent, a plate face of the plate-shaped graphite particles is likely to be oriented, on a current collector, so as to be substantially parallel to a surface of the current collector.

A preferable aromatic vinyl copolymer contains the vinyl aromatic monomer unit, and another monomer unit other than the vinyl aromatic monomer unit (hereinafter, referred to as “another or other monomer unit”). In the aromatic vinyl copolymer, the vinyl aromatic monomer unit is likely to adsorb onto the plate-shaped graphite particles, whereas the other monomer unit is likely to exhibit affinity with a solvent or resin, and with functional groups in the surface of the plate-shaped graphite particles.

The higher the aromatic vinyl copolymer has a content rate of the vinyl aromatic monomer unit, the more the adsorption amount of the aromatic vinyl copolymer onto the plate-shaped graphite particles augments. A preferable content rate of the vinyl aromatic monomer unit is from 10% by mass to 98% by mass; a more preferable content rate is from 30% by mass to 98% by m or an especially preferable content rate is from 50% by mass to 95% by mass, with respect to the entire aromatic vinyl copolymer. When the content rate of the vinyl aromatic monomer unit becomes lower than 10% by mass, an adsorption amount of the aromatic vinyl copolymer onto the plate-shaped graphite particles declines. When the content Late of the vinyl aromatic monomer unit becomes higher than 98% by mass, the affinity between the plate-shaped graphite particles and a solvent or resin becomes low. Accordingly, a dispersing property of the plate-shaped graphite particles into the solvent, or into the resin, declines.

As for the substituent group in formula (1), the following are given, for instance: an amino group, a carboxyl group, a carboxylate ester group, a hydroxyl group, an amide group, an imino group, a glycidyl group, an alkoxy group, a carbonyl group, an imide group, and a phosphate ester group. To make the dispersing property of the plate-shaped graphite particles high into a solvent, or into a resin, a preferable substituent group is an alkoxy group, and a preferable alkoxy group is a methoxy group.

As for the vinyl aromatic monomer unit, the following are given, for instance: a styrene monomer unit, a vinyl naphthalene monomer unit, a vinyl anthracene monomer unit, a vinyl pyrene monomer unit, a vinyl anisole monomer unit, a vinyl benzoate ester monomer unit, and an acetyl styrene monomer unit. Among the above, from a standpoint of upgrading the dispersing property of the plate-shaped graphite particles into a solvent, or into a resin, the following are preferable: the styrene monomer unit, the vinyl naphthalene monomer unit, and the vinyl an monomer unit.

A preferable other monomer unit is a monomer unit. derived from at least one member of monomers selected from the group consisting of (meth)acrylic acid, (meth)acrylates, (meth)acrylamides, vinyl imidazoles, vinyl pyridines, maleic acid anhydride, and maleimides. Note that, in the present description, the “(meth)acrylic acid” signifies both of “acrylic acid” and “methacrylic acid.”

Adsorbing the aromatic vinyl copolymer including such another monomer unit onto a surface of the plate-shaped graphite particles results in upgrading the affinity between the plate-shaped graphite particles and a solvent or resin, and accordingly leads to enabling the plate-shaped graphite particles to disperse satisfactorily within the solvent, or within the resin.

As for the (meth)acrylates, alkyl (meth)acrylate, and substituted alkyl (meth)acrylate are given. As for the substituted alkyl (meth)acrylate, hydroxy alkyl (meth)acrylate, and amino alkyl (meth)acrylate are given, for instance.

As for the (meth)acrylamides, (meth)acrylamide, N-alkyl (meth)acrylamide, and N,N-dialkyl (meth)acrylamide are given.

As for the vinyl imidazoles, 1-vinyl imidazole is given.

As for the vinyl pyridines, 2-vinyl pyridine, and 4-vinyl pyridine are given.

As for the maleimides, maleimide, alkyl maleimide, and aryl maleimide are given.

From such a standpoint as the dispersing property of the plate-shaped graphite particles upgrades, preferable another monomer unit is as follows: alkyl (meth)acrylate, hydroxy alkyl (meth)acrylate, amino alkyl (meth)acrylate, N,N-dialkyl (meth)acrylamide, 2-vinyl pyridine, 4-vinyl pyridine, and aryl maleimide. More preferable another monomer unit is as follows: hydroxy alkyl (meth)acrylate, N,N-dialkyl (meth)acrylamide, 2-vinyl pyridine, and aryl maleimide. Especially preferable another monomer unit is phenyl maleimide.

As for examples of the aforementioned aromatic vinyl copolymer, the following are given, for instance: random copolymers of styrene (or “ST”) and N,N-dimethyl methacrylamide (or “DMMAA”) ; random copolymers of 1-vinyl naphthalene (or “VN”) and “DMMAA”; random copolymers of 4-vinyl anisole (or “VA”) and “DMMAA”; random copolymers of “ST” and N-phenyl maleimide (or “PM”); random copolymers of “ST” and 1-vinyl imidazole (or “VI”); random copolymers of “ST” and 4-vinyl pyridine (or “4VP”); random copolymers of “ST” and N,N-dimethyl amino ethyl methacrylate (or “DMAEMA”); random copolymers of “ST” and methyl methacrylate (or “MMA”) ; random copolymers of “ST” and hydroxy ethyl methacrylate (or “HEMA”); random copolymers of “ST” and 2-vinyl pyridine (or “2VP”); block copolymers of “ST” and “2VP”: block copolymers of “ST” and “MMA”: and block copolymers of “ST” and polyethylene oxide (or “PEO”)

As for a number average molecular weight of the aromatic vinyl copolymer, a preferable number average molecular weight is from 1,000 to 1,000,000; or a more preferable number average molecular weight is from 5,000 to 100,000. When the number average molecular weight of the aromatic vinyl copolymer becomes less than 1,000, the adsorption ability with respect to the plate-shaped graphite particles tends to decline. On the contrary, when the number average molecular weight becomes larger than 1,000,000, the dispersing property of the plate-shaped graphite particles into a solvent, or into a resin, declines, or the viscosity rises so markedly that the handling tends to become difficult. Note that, for the number average molecular weight of the aromatic vinyl copolymer, a value is used, the value measured by a gel permeation chromatography (of which the columns are “Shodex GPC K-805L” and “Shodex GPC K-800RL (both of which are produced by SHOWA DENKO Co., Ltd.) and the eluent is chloroform), and then converted with standard polystyrene.

As the aromatic vinyl copolymer, either using one of the random copolymers, or using one of the block copolymers is allowed. From such a standpoint, as the dispersing property of the plate-shaped graphite particles into a solvent, or into a resin, upgrades, using one of the block copolymers is preferable.

As for a content of the aromatic vinyl copolymer in the plate-shaped graphite particles with the aromatic vinyl copolymer adhered on the surface, a preferable content is from 10⁻⁷ to 10⁻¹ parts by mass; or a more preferable content is from 10⁻⁵ to 10⁻² parts by mass, with respect to the plate-shaped graphite particles taken as 100 parts by mass. When the content of the aromatic vinyl copolymer becomes less than 10⁻⁷ parts by mass, the dispersing property of the plate-shaped graphite particles into a solvent, or into a resin, tends to decline, because the aromatic vinyl copolymer adsorbs toward the plate-shaped graphite particles insufficiently. On the contrary, when the content of the aromatic vinyl copolymer becomes more than 10⁻¹ parts by mass, the aromatic vinyl copolymer, which does not adsorb directly onto the plate-shaped graphite particles, comes to exist.

Producing plate-shaped graphite particles with the aromatic vinyl copolymer adhered onto the surface is possible by the following process. Specifically, a production process for the plate-shaped graphite particles with the aromatic vinyl copolymer adhered onto the surface comprises: a mixing step of mixing raw-material graphite particles, an aromatic vinyl copolymer containing a vinyl aromatic monomer unit expressed by aforementioned formula (1), a compound involving hydrogen peroxide, and a solvent; and a pulverizing step of subjecting a mixture obtained at the mixing step to a pulverization treatment.

As for the raw-material graphite particles, publicly-known graphite having a graphitic structure, such as artificial graphite, scale-shaped graphite, massive graphite or earthy graphite, is given, for instance. As for a particle diameter of the raw-material graphite particles, a preferable particle diameter is from 0.01 mm to 5 mm; or a more preferable particle diameter is from 0.1 mm to 1 mm.

For the aromatic vinyl copolymer, the same copolymers as the copolymers explained above are employable.

As for the compound involving hydrogen peroxide, the following are given: complexes of hydrogen peroxide and compounds having a carbonyl group; coordination complexes in which hydrogen peroxide is coordinated to compounds, such as quaternary ammonium salts, potassium fluoride, rubidium carbonate, phosphoric acid, urea, or the like. As the compounds having a carbonyl group, the following are given, for instance: urea, carboxylic acids (e.g., benzoic acid, salicylic acid, and the like); ketone (e.g., acetone, methyl ethyl ketone, and so forth); and carboxylate ester (e.g., methyl benzoate, ethyl salicylate, and so on). As for the compound involving hydrogen peroxide, a complex of hydrogen peroxide and one of the compounds having a carbonyl group is preferable.

Such a compound involving hydrogen peroxide as above acts as an oxidizing agent, and makes the peeling between carbon layers easier, without destructing the graphitic structure of the raw-material graphite particles. In other words, the compound involving hydrogen peroxide causes cleavage to progress, while intruding between the carbon layers to oxidize the layers in the surface; and then the aromatic vinyl copolymer intrudes between the cleaved carbon layers to stabilize cleaved facets; and accordingly interlayer peeling is facilitated. As a result, the aromatic vinyl copolymer adheres onto a surface of the plate-shaped graphite particles

For the solvent, the following are preferable; dimethylformamide (or DMF), chloroform, dichloromehtane, chlorobenzene, dichlorobenzen, N-methylpyrrolidone (or NMP), hexane, toluene, dioxane, propanol, y-picoline, acetonitrile, dimethyisulfoxide (or DMSO), or dimethylacetamide (or DMAC); or the following are more preferable: dimethylformamide (or DMF), chloroform, dichloromehtane, chlorobenzene, dichlorobenzen, N-methylpyrrolidone (or NMP), hexane, or toluene.

In the mixing step, the raw-material graphite particles, the aromatic vinyl copolymer, the compound involving hydrogen peroxide, and the solvent are mixed with each other. As for a mixing amount of the raw-material graphite particles, a preferable mixing amount is from 0.1 g/L, to 500 g/L; or a more preferable mixing amount is from 10 g/L to 200 g/L, per 1-L solvent. When the mixing amount of the raw-material graphite particles becomes less than 0.1 g/L per 1-L solvent, a consumed amount of the solvent augments to be disadvantageous economically. On the contrary, when the mixing amount exceeds 500 g/L per 1-L solvent, a liquid viscosity rises so that the handling becomes difficult.

Moreover, as for a mixing amount of the aromatic vinyl copolymer, a preferable mixing amount is from 0.1 part by mass to 1,000 parts by mass; or a more preferable mixing amount is from 0.1 part by mass to 200 parts by mass, with respect to the raw-material graphite particles taken as 100 parts by mass. When the mixing amount of the aromatic vinyl copolymer becomes less than 0.1 part by mass with respect to the raw-material graphite particles taken as 100 parts by mass, the dispersing property of obtainable plate-shaped graphite particles tends to decline. On the contrary, when the mixing amount of the aromatic vinyl copolymer exceeds 1, 000 parts by mass with respect to the raw-material graphite particles taken as 100 parts by mass, not only the aromatic vinyl copolymer becomes less likely to dissolve in the solvent, but also a liquid viscosity rises so that the handling becomes difficult.

As for a mixing amount of the compound involving hydrogen peroxide, a preferable mixing amount is from 0.1 part by mass to 500 parts by mass; or a more preferable mixing amount is from 1 part by mass to 100 parts by mass, with respect to the raw-material graphite particles taken as 100 parts by mass. When the mixing amount of the compound involving hydrogen peroxide becomes less than 0.1 part by mass with respect to the raw-material graphite particles taken as 100 parts by mass, the dispersing property of obtainable plate-shaped graphite particles tends to decline. On the contrary, when the mixing amount of the compound involving hydrogen peroxide goes beyond 500 parts by mass with respect to the raw-material graphite particles taken as 100 parts by mass,the raw-material graphite particles are oxidized excessively. Accordingly, the conductive property of obtainable plate-shaped graphite particles tends to decline.

In the pulverizing step, the mixture obtained at the mixing step is subjected to a pulverization treatment to pulverize the raw-material graphite particles to plate-shaped graphite particles. Onto a surface of the thus generated plate-shaped graphite particles, an aromatic vinyl copolymer adsorbs. As for the pulverization treatment, an ultrasonic treatment., a treatment by ball mill, wet pulverizing, blast crushing, and mechanical pulverizing are given, for instance. In the ultrasonic treatment, from 15 to 400 kHz are preferable as for the oscillatory frequency, and 500 W or less are preferable as for the output. As for the pulverization treatment, an ultrasonic treatment, or a wet pulverization treatment is preferable. At the pulverizing step, obtaining plate-shaped graphite particles is possible by pulverizing the raw-material graphite particles, without destructing the graphitic structure of the raw-material graphite particles. Moreover, as for a temperature at the time of the pulverization treatment, setting the temperature at from −20° C. to 100° C. is possible, for instance. Moreover, as for a time for the pulverization treatment, setting the time at from 0.01 hour to 50 hours is possible, for instance.

In a negative-electrode active-material layer, at least some of the plate-shaped graphite particles are also allowed to have the plate face which is oriented so as to be substantially parallel to a surface of a current collector, but an orientation is preferred to be collapsed by the presence of the first active-material powder. Since a collapsed orientation results in exposing a surface, which is directed to cross with respect to the plate face of the plate-shaped graphite particles, in the travelling directions of lithium ions, the lithium ions come in and out inside the plate-shaped graphite particles as well, and accordingly the charged and discharged capacities become large. Therefore, in a negative-electrode active-material layer, a plate face of at least some of the plate-shaped graphite particles is preferred to cross with respect to a surface of a current collector.

Moreover, when the aromatic vinyl copolymer mentioned above adheres onto a surface of the plate-shaped graphite particles, since the plate-shaped graphite particles disperse without agglomerating within a solvent under such a condition as the plate-shaped graphite particles have been put in the solvent, precipitations are less likely to occur so that forming a uniform negative-electrode active-material layer is possible.

To the negative-electrode active material, adding a powder, which is composed of at least one member selected from the group consisting of Si, Si compounds, Sn and Sn compounds, is also possible, in addition to the first active-material powder and second active-material powder. Because the Si, Si compounds, Sn, and Sn compounds undergo expansions and contractions at the time of charging and discharging operations, a more preferable crystallite size of the Si, Si compounds, Sn and Sn compounds is from 1 nm to 300 nm in order to make the expansions and contractions small.

As for the Si, the following are usable: a pulverized product of single-crystal Si; vapor-phase deposition. Si; nanometer-size silicon produced by heat treating a lamellar polysilane making a structure in which multiple six-membered rings constituted of a silicon atom are disposed one after another, and which is expressed by a compositional formula, (SiH)ₙ; and the like.

As for the Si compounds, a silicon oxide expressed by SiOₓ (where 0.3≦“x”≦1.6) is preferable, for instance. Each of particles in a powder of the silicon oxide is composed of SiOₓ having been decomposed into fine Si, and SiO₂ covering the Si, by a disproportionation reaction. When the “x” is less than the lower-limit value, volumetric changes become too large at the time of charging and discharging operations because the Si ratio becomes so high that the cyclability declines. Moreover, when the “x” exceeds the upper-limit value, the Si ratio declines so that the energy density comes to decline. A preferable range is 0.5≦“x”1.5; or a more desirable range is 0.7≦“x≦”1.2.

As for the other Si compounds, the following are employable, for instance; SIB₄, SiB₆, MG₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SnSiO₃, LiSiO, and the like.

As for the Sn, commercially available Sn powers are employable. As for the Sn compounds, the following are employable, for instance: SnO_{w} (where 0<“w”≦2), SnSiO₃, LiSnO, and tin alloys (e.g., Cu—Sn alloys, Co—Sn alloys, and the like).

Since the Si, Si compounds and Sn compounds have a low conductive property, respectively, a preferable content thereof within the negative-electrode active material is 50% by mass or less when a summed amount of the first active-material powder and second active-material powder is taken as 100% by mass.

### Mixing Ratio

When a sum of the first active-material powder and second active-material powder is taken as 100% by mass, including the second active-material powder in an amount of from 10 to 90% by mass is preferable; or including the second active-material powder in an amount of from 30 to 70% by mass is more preferable. When the second active-material powder is less than 10% by mass, effecting the advantages is less likely to be noticed; whereas, when the second active-material powder exceeds 90% by mass, the charged and discharged capacities of an electric storage apparatus decline.

### Negative Electrode

The negative-electrode active material according to the present invention is used for a negative electrode of an electric storage apparatus. The negative electrode comprises a current collector, and a negative-electrode active-material layer arranged on a surface of the current collector. A “current collector” means a chemically inactive high electron conductor for keeping an electric current flowing to electrodes during the discharging or charging operations of the electric storage apparatus. As a material usable for the current collector, giving the following is possible, for instance: metallic materials, such as stainless steels, titanium, nickel, aluminum and copper; or conductive resins. Moreover, the current collector is capable of taking such a form as foils, sheets and films. Consequently, as the current collector, a metallic foil, such as copper foils, nickel foils, aluminum foils and stainless-steel foils, is usable suitably, for instance. Making a thickness of the current collector fall in a range f from 10 μm to 100 μm is possible.

The following steps enable a negative-electrode active-material layer of the negative electrode for a nonaquecus-system secondary battery, for instance, to be formed using the negative-electrode active material according to the present invention: adding a proper amount of an organic solvent to the first active-material powder, the second active-material powder, and a binder to mix the components each other to prepare a slurry; coating the slurry on the current collector by such a method as a roll-coating method, a dip-coating method, a doctor-blade method, a spray-coating method or a curtain-coating method; and then drying or curing the binder. Although a conductive additive, such as acetylene black or KETJENBLACK, is unnecessary, adding the conductive additive is also allowed, if needed.

Although the binder is required to bind the active material, and so on, together in an amount as less as possible, a desirable addition amount of the binder is from 0.5% by mass to 50% by mass to a summed amount of the active material and binder. When the binder is less than 0.5% by mass, the formability of an electrode declines; whereas the energy density of an electrode becomes low when the addition amount exceeds 50% by mass.

For the binder, the following are exemplified: polyvinylidene fluoride (e.g., polyvinylidene difluoride (or PVdF)), polytetrafluoroethylene (or PTFE), styrene-butadiene rubber (or SBR), polyimide (or PT), polyamide-imide (or PAI), carboxymethyl cellulose (or CMC), polyvinylchloride (or PVC), methacrylic resins (or PMAs), polyacrylonitrile (or PAN), modified polyphenylene oxide (or PPO), polyethylene oxide (or PEO), polyethylene (or PE), polypropylene (or PP), polyacrylic acids (or PAA), and the like.

Using the polyvinylidene fluoride as the binder enables a negative electrode to lower in the potential so that upgrading an electric storage apparatus in the voltage becomes feasible. Moreover, using the polyamide-imide (or PAI) or polyacrylic acids (or PAA) as the binder upgrades an initial efficiency and discharged capacity.

The conductive additive is added in order to enhance the conductive property of an electrode. As the conductive additive, the following are addable independently, or two or more of the following are combinable to add: carbonaceous fine particles, such as carbon black, graphite, acetylene black (or AB) and KETJENBLACK (or KB (registered trademark)); and gas-phase-method carbon fibers (or vapor-grown carbon fibers (or VGCF)). Although an employment amount of the conductive additive is not at all restrictive especially, setting the employment amount is possible at from 0 to 100 parts by mass approximately with respect to the active material taken as 100 parts by mass, for instance. When an amount of the conductive additive exceeds 100 parts by mass, not only the formability of an electrode worsens but also the energy density thereof becomes low.

To the organic solvent, any restrictions are not at all imposed especially, and even a mixture of multiple solvents does not matter at all. An especially preferable solvent is N-methyl-2-pyrrolidone, or a mixed solvent of N-methyl-2-pyrrolidone and an ester-based solvent (such as ethyl acetate, n-butyl acetate, butyl cellosolve acetate, or butyl carbitol acetate) or a glyme-based solvent (such as diglyme, triglyme, or tetraglyme).

Electric Storage Apparatus

When an electric storage apparatus according to the present invent ion makes a lithium-ion secondary battery, pre-doping the negative electrode with lithium is also possible. To dope the negative electrode with lithium, such an electrode forming technique is utilizable as assembling a half cell using metallic lithium for one of the counter electrodes, and then doping the negative electrode with lithium electrochemically, for instance. The doping amount of lithium is not at all restricted especially.

When an electric storage apparatus according to the present invention makes a lithium-ion secondary, battery, publicly-known positive electrodes, electrolytic solutions and separators are usable without any special limitations at all. An allowable positive electrode is positive electrodes being employable in nonaqueous-system secondary batteries. The positive electrode comprises a current collector, and a positive-electrode active-material layer bound together on the current collector. The positive-electrode active-material layer includes a positive-electrode active material, and a binder, but the positive-electrode active-material layer further including a conductive additive is also permissible. The positive-electrode active material, conductive additive and binder are not at all limited especially, and accordingly are allowed to be constituent elements being employable in nonaqueous-system secondary batteries.

As for the positive-electrode active material, the following are given: metallic lithium, LiCoO₂, LiNi_{1/3}Co_{1/3}Mn_{1/3}O₂, Li₂MnO₃, sulfur, and the like. An allowable current collector is current collectors, such as aluminum, nickel and stainless steels, to be commonly employed for the positive electrodes of lithium-ion secondary batteries. An employable conductive additive is the same conductive additives as the conductive additives set forth in the above-mentioned negative electrode.

The electrolytic solution is a solution in which a lithium metallic salt, namely, an electrolyte, has been dissolved in an organic solvent. The electrolytic solution is not at all limited especially. As the organic solvent, an aprotic organic solvent is usable. For example, at least one member selected from the group consisting of the following is usable: propylene carbonate (or PC), ethylene carbonate (or EC), dimethyl carbonate (or DMC), diethyl carbonate (or DEC), ethyl methyl carbonate (or EMC), and the like. Moreover, as for the electrolyte to be dissolved, a lithium metallic salt, such as LiPF₆, LiBF₄, LiAsF₆, LiI, LiClO₄ or LiCF₃SO₃, being soluble in the organic solvent is usable.

For example, the following solution is employable: a solution comprising a lithium metallic salt, such as LiClO₄, LiPF₆, LiBF₄ or LiCF₃SO₃, dissolved in a concentration of from 0.5 mol/L to 1.7 mol/L approximately in an organic solvent, such as ethylene carbonate, dimethyl carbonate, propylene carbonate or dimethyl carbonate.

The separator is not at all limited especially as far as being separators which are capable of being employed for nonaqueous-system secondary batteries. The separator is one of the constituent elements isolating the positive electrode and negative electrode from one another and retaining the electrolytic solution therein, and accordingly a thin microporous membrane, such as polypropylene or polyethylene, is usable.

When an electric storage apparatus according to the present invention makes a nonaqueous-system secondary battery, the configuration is not at all limited especially, and accordingly various configurations, such as cylindrical types, laminated types and coin types, are adoptable. Even when any one of the configurations is adopted, the separators are interposed or held between the positive electrodes and the negative electrodes to make electrode assemblies. Then, a battery is formed by sealing the electrode assemblies hermetically in a battery case, along with the electrolytic solution, after connecting intervals from the positive-electrode current collectors and negative-electrode current collectors up to the positive-electrode terminals and negative-electrode terminals, which lead to the outside, with leads, and the like, for collecting electricity.

Hereinafter, embodiment modes according to the present invention will be explained concretely by examples and comparative examples.

### FIRST EXAMPLE

### Preparation of Plate-Shaped Graphite Particles

1.82-g steyrene (or ST), 0.18-g N-phenyl maleimide (or PM), 10-mg azobisisobutyronitrile (or AIBN), and 5-mL toluene were mixed each other, and then a polymerization reaction was carried out at 60° C. for 6 hours under a nitrogen atmosphere. After leaving products to cool, the products were purified by reprecipitation using chloroform-ether. Accordingly, an ST-PM (with a ratio of 91:9) random copolymer was obtained in an amount of 0.66 g. A number average molecular weight (i.e., Mn) of the ST-PM (with a ratio of 91:9) random copolymer was 58,000.

The number average molecular weight (i.e., Mn) was herein measured using a gel permeation chromatography (e.g., “Shodex GPC101” produced by SHOWA DENKO Co., Ltd.) under the following conditions:
Columns: “Shodex GPC K-805L” and “Shodex GPC K-800RL both of which were produced by SHOWA DENKO Co., Ltd.;
Eluent: Chloroform;
Measurement Temperature: 25° C.;
Sample Concentration: 0.1 mg/mL; and
Detection Means: RI.

Note that the number average molecular weight (i.e., Mn) designated above was a value converted with standard polystyrene.

20-mg graphite particles (e.g., “EXP-P” produced by NIPPON GRAPHITE INDUSTRIES, Ltd., and having particle diameters of from 100 to 600 μm), 80-mg urea-hydrogen peroxide inclusion complex, 20-mg ST-PM (with a ratio of 91:9) random copolymer mentioned above, and 2-mL N,N-dimethylformamide (or DMF) were mixed each other, and then the resulting mixture was subjected to an ultrasonic treatment (with an output of 250 W) at room temperature for five hours to obtain a dispersion liquid of plate-shaped graphite particles. The plate-shaped graphite particles were filtered from out of the dispersion liquid, washed with dimethylformamide (or DMF), and vacuum dried, to obtain a plate-shaped graphite powder. Upon observing the plate-shaped graphite particles constituting the plate-shaped graphite powder by scanning electron microscope (or SEM), the plate-shaped graphite particles had major diameters of from 10 μm to 20 μm, and had minor diameters of from 3 μm to 10 μm, and thicknesses of from 30 nm to 80 nm.

### Surface Analysis of Plate-Shaped Graphite Particles

A coated film of the aforementioned plate-shaped graphite particles was prepared by coating a dispersion liquid of the plate-shaped graphite particles (i.e., a dispersion liquid with the ST-PM (with a ratio of 91:9) random copolymer added) on an indium foil, and then drying the dispersion liquid. Regarding the coated film of the plate-shaped graphite particles, a time-of-flight secondary ion mass spectrometry (or TOF-SIMS for positive ions exhibiting “m/z” of from 0 to 250) was carried out, thereby analyzing molecules existing in a surface of the coated film of the plate-shaped graphite particles. As a result, the ST-PM (with a ratio of 91:9) random copolymer was found to adhere onto the surface of the coated film of the plate-shaped graphite particles. Moreover, from fragment patterns of the ST-PM (with a ratio of 91:9) random copolymer, of components of the ST-PM (with a ratio of 91:9) random copolymer, the copolymer components containing more vinyl aromatic monomer units were found to be likely to adsorb onto the surface of the plate-shaped graphite particles.

Moreover, upon carrying out an X-ray photoelectron spectroscopic (or XPS) measurement regarding the obtained film of the plate-shaped graphite particles, hydroxyl groups were ascertained to bond to carbon atoms in the superficial vicinity of the coated film (i.e., in an area from the surface to a depth of 10 nm). In addition, a carbon amount and oxygen amount in the superficial vicinity of the coated film were measured to seek for atomic ratios of the carbon and oxygen. As a result, the oxygen atoms were found to be 1.13 with respect to the carbon atoms taken as 100. Moreover, in the graphite particles serving as the raw material, the oxygen atoms were found to be about 2 with respect to the carbon atoms taken as 100.

Therefore, compared with the raw-material graphite particles, the oxygen atoms declined to about 1 with respect to the carbon atoms taken as 100 in the plate-shaped graphite particles From the fact, the aromatic vinyl copolymer was confirmed to adsorb onto the hydroxyl groups in the surface of the plate-shaped graphite particles to cover the plate-shaped graphite particles.

### Formation of Negative Electrode

A slurry was prepared by dissolving the following in N-methyl-2-pyrrolidone (or NMP), and then mixing the following each other therein: a granulated graphite powder (produced by NIPPON GRAPHITE INDUSTRIES, Ltd., and exhibiting an average particle diameter D₅₀ of 300 μm) in an amount of 45 parts by mass; the aforementioned plate-shaped graphite powder in an amount of 45 parts by mass; and polyvinylidene fluoride serving as a binder in an amount of 10 parts by mass. The slurry was coated onto a surface an electrolyzed copper foil (i.e., a current collector) having 20 μm in thickness using a doctor blade, thereby forming a negative-electrode active-material layer on the copper foil.

Thereafter, the negative-electrode active-material layer was dried at 80° C. for 20 minutes, and thereby the NMP was removed from the negative-electrode active-material layer by evaporating the NMP. After further drying the negative-electrode active-material layer, the current collector and negative-electrode active-material layer were adhesion joined firmly one another by a roll pressing machine. The adhesion-joined substance was vacuum heated at 100° C. for 2 hours, thereby forming a negative electrode of which the active-material layer had a thickness of 30 μm approximately.

### Fabrication of Lithium-Ion Secondary Battery

Using as an evaluation electrode the negative electrode fabricated through the above-mentioned procedures, a lithium-ion secondary battery (i.e., a half cell) was fabricated. A metallic lithium foil with 500 μm in thickness was set as the counter electrode.

The counter electrode was cut out to φ13 mm, and the evaluation electrode was cut out to φ11 mm. Then, a separator (e.g., a glass filter produced by HOECHST CELANESE Corporation, and “Celgard 2400”) was set or held between the two to make an electrode-assembly battery. The electrode-assembly battery was accommodated in a battery case (e.g., a member for CR2032-type coin battery, a product of HOSEN Co., Ltd.). Moreover, into the battery case, a nonaqueous electrolytic solution, which comprised: a mixed solvent composed of ethylene carbonate and diethyl carbonate mixed one another in a ratio of 1:1 by volume; and LiPF₆ dissolved in the mixed solvent in a concentration of 1 M, was injected. Then, the battery case was sealed hermetically to obtain a lithium-ion secondary battery.

### FIRST COMPARATIVE EXAMPLE

A slurry was prepared by dissolving the following in NMP, and then mixing the following one another therein: the same granulated graphite powder as used in the first example in an amount of 90 parts by mass; and polyvinylidene fluoride in an amount of 10 parts by mass. The slurry was coated onto a surface of an electrolyzed copper foil (i.e., a current collector) having 20 μm in thickness using a doctor blade, thereby forming a negative-electrode active-material layer on the copper foil.

Thereafter, the negative-electrode active-material layer was dried at 80° C. for 20 minutes, and thereby the NMP was removed from the negative-electrode active-material layer by evaporating the NMP. After further drying the negative-electrode active-material layer, the current collector, and the negative-electrode active-material layer were adhesion joined firmly by a roll pressing machine. The adhesion-joined substance was vacuum heated at 100° C. for 2 hours, thereby forming a negative electrode of which the active-material layer had a thickness of 30 μm approximately.

Other than using the negative electrode, a lithium-ion secondary battery was obtained in the same manner as the first example.

### SECOND COMPARATIVE EXAMPLE

A slurry was prepared by dissolving the following in NMP, and then mixing the following one another therein: the same plate-shaped graphite powder as the plate-shaped graphite powder according to the first example in an amount of 90 parts by mass; and polyvinylidene fluoride in an amount of 10 parts by mass. The slurry was coated onto a surface of an electrolyzed copper foil (i.e., a current collector) having 20 μm in thickness using a doctor blade, thereby forming a negative-electrode active-material layer on the copper foil.

Thereafter, the negative-electrode active-material layer was dried at 80° C. for 20 minutes, and thereby the NMP was removed from the negative-electrode active-material layer by evaporating the NMP. After further drying the negative-electrode active-material layer, the current collector, and the negative-electrode active-material layer were adhesion joined firmly by a roll pressing machine. The adhesion-joined substance was vacuum heated at 100° C. for 2 hours, thereby forming a negative electrode of which the active-material layer had a thickness of 30 μm approximately.

Other than using the negative electrode, a lithium-ion secondary battery was obtained in the same manner as the first example.

### First Evaluation Test

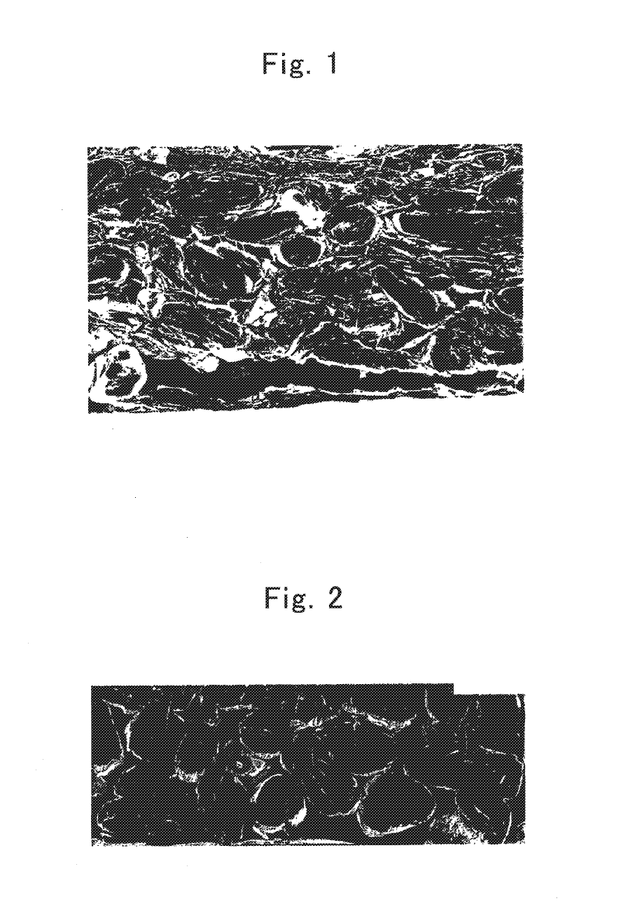

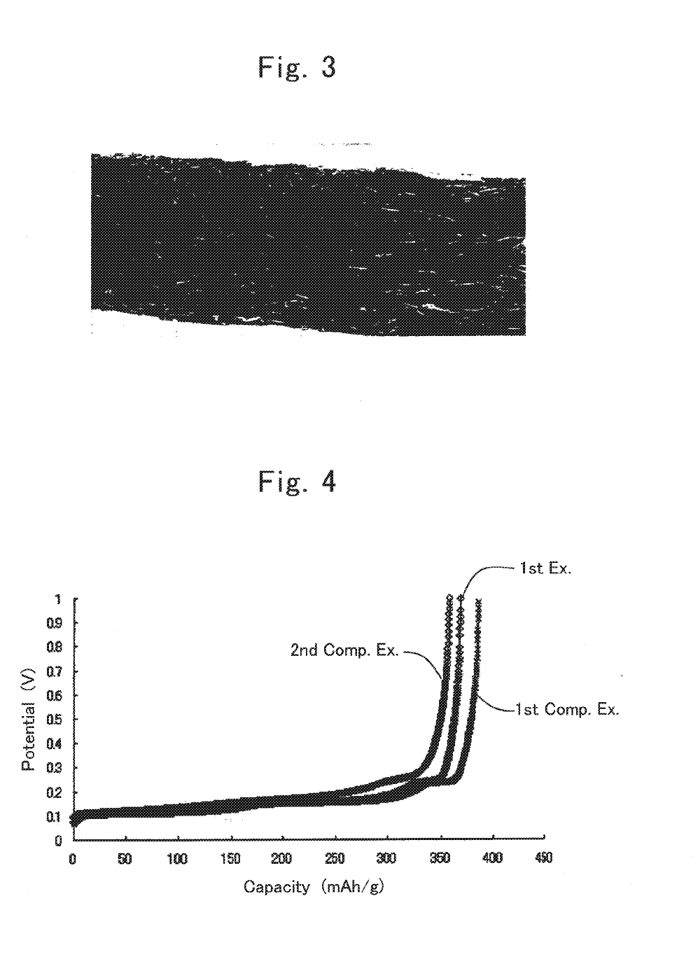

FIGS. 1 through 3 illustrate SEM images of a cross-section of the negative electrodes formed in the first example and first and second comparative examples, respectively. As illustrated in FIG. 3, the plate-shaped graphite particles are found to be oriented parallel with respect to the current collector (i.e., the white plate-shaped substance on the lower part) in the second comparative example. However, in the first example, the plate-shaped graphite particles having cross-sectionally flat configurations are found to exist randomly without orienting in a single direction, and to be inhibited from orienting in a single direction by the granulated graphite particles.

### Second Evaluation Test

The lithium-ion secondary batteries according to the first example as well as the first and second comparative examples were used to compare the battery performance with each other. FIG. 4 illustrates the charging curves at 0.3 C. Since all of the lithium-ion secondary batteries exhibited a capacity of 95% or more, respectively, when the operating voltage was 0.5 V or less, the lithium-ion secondary battery according to the first example having the negative-electrode active material, which comprised the mixed granulated graphite powder and plate-shaped graphite powder, had battery performance substantially equivalent to the battery performance of the first comparative example having the negative-electrode active material, which consisted of the granulated graphite powder alone.

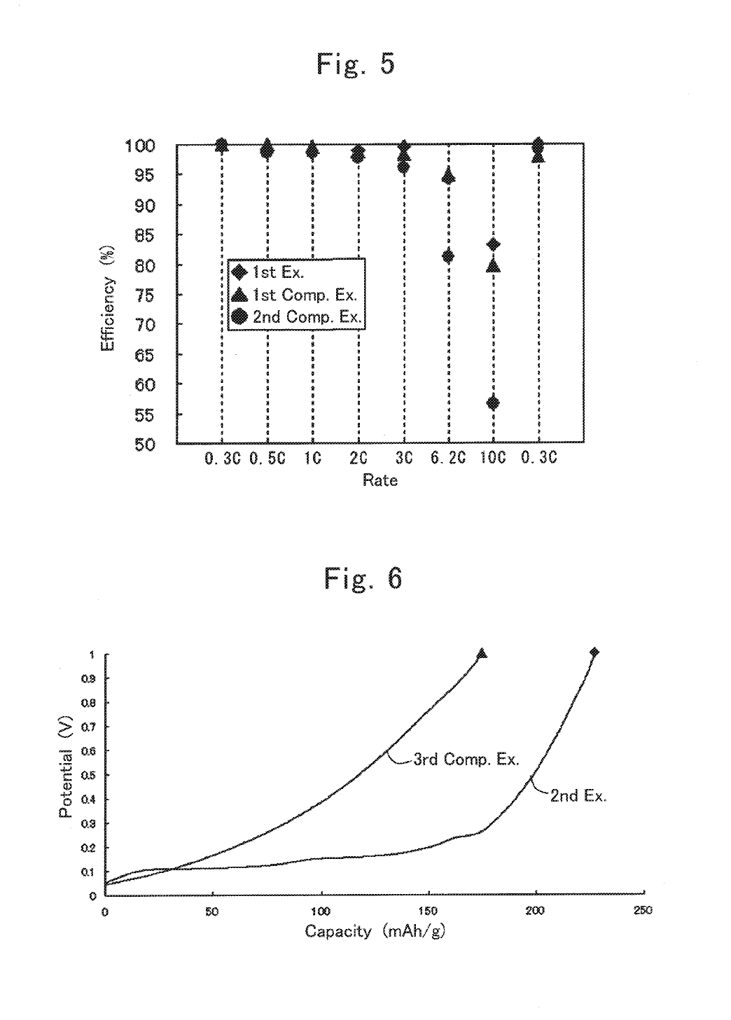

Next, the capacities were measured while changing current values from 1 C to 10 C, and then ratios of the respective capacities with respect to the 1 C capacities were computed. FIG. 5 illustrates a graph of rate efficiencies; whereas Table 1 shows values (i.e., rate efficiencies) of the 10 C capacities with respect to the 1 C capacities

TABLE 1

| | 1 C | 10 C | Rate |
|---|---|---|---|
| | Capacity | Capacity | Efficiency |
| | (mAh/g) | (mAh/g) | (% at 10 C) |
| First | 332 | 275 | 83.1 |
| Example | | | |
| First | 345 | 274 | 79.5 |
| Comparative | | | |
| Example | | | |
| Second | 322 | 177 | 55.1 |
| Comparative | | | |
| Example | | | |

The lithium-ion secondary battery according to the first example had the rate efficiency improved by about 4% with respect to the first comparative example, and the improvement was an advantage resulting from mixing the plate-shaped graphite powder. In consideration of FIGS. 1 through 3, the plate-shaped graphite particles are believed to orient randomly in the first example, so that a surface of the plate-shaped graphite particles, which arise by cutting with a plane crossing with respect to the lamination direction of graphene, is exposed in the travelling directions of lithium ions with a high probability. Accordingly, the lithium ions are believed to come in and out inside the plate-shaped graphite particles as well.

### SECOND EXAMPLE

Other than using a hard carbon powder (produced by KUREHA CORPORATION, and exhibiting an average particle diameter D₅₀ of 8 μm), instead of the granulated graphite powder, in an equal amount, a negative-electrode active-material layer was formed in the same manner as the first example, and then a lithium-ion secondary battery was fabricated in the same manner as the first example.

### THIRD COMPARATIVE EXAMPLE

Other than using the same hard carbon powder as used in the second example, instead of the plate-shaped graphite powder, in an amount of 90 parts by mass, a negative-electrode active-material layer was formed in the same manner as the second comparative example, and then a lithium-ion secondary battery was fabricated in the same manner as the first example.

### Third Evaluation Test

The lithium-ion secondary batteries according to the second example and third comparative example were used to compare the battery performance with one another. First of all, FIG. 6 illustrates the charging curves at 1 C. The lithium-ion secondary battery according to the second example having the negative-electrode active material, which comprised the mixed hard carbon powder and plate-shaped graphite powder, was improved apparently in terms of the battery characteristic, compared with the third comparative example having the negative-electrode active material, which consisted of the hard carbon powder alone. Moreover, since a 90%—or—more capacity of the total was exhibited when the operating voltage was 0.5 V or less, such another advantage as lowering the voltage was ascertainable in the lithium-ion secondary battery according to the second example.

Next., the rate efficiencies were measured in the same manner as the second evaluation test, and then Table 2 shows values of the 10 C capacities with respect to the 1 C capacities.

TABLE 2

| | 1 C | 10 C | Rate |
|---|---|---|---|
| | Capacity | Capacity | Efficiency |
| | (mAh/g) | (mAh/g) | (% at 10 C) |
| Second | 226 | 193 | 85.5 |
| Example | | | |
| Third | 175 | 148 | 84.7 |
| Comparative | | | |
| Example | | | |

A lithium-ion secondary battery comprising hard carbon serving as the negative-electrode active material has been found to have small capacities, although the output characteristic is satisfactory. To make the capacities larger, though such a means has been available as adding natural graphite, such a contradiction occurs as the output declines, if doing the addition. However, as understood from Table 2, adding the plate-shaped graphite powder leads to enabling the output to be inhibited from declining while maintaining the rate efficiency. In other words, adding the plate-shaped graphite powder results in enabling the contradictory event between the capacity and the output to be solved.

### INDUSTRIAL APPLICABILITY

The electric storage apparatus according to the present invention is utilizable for secondary batteries, electric double-layer capacitors, lithium-ion capacitors, and the like. Moreover, the present electric storage apparatus is useful for nonaqueous-system secondary batteries utilized for driving the motors of electric automobiles and hybrid automobiles, and for personal computers, portable communication gadgets, home electric appliances, office devices, industrial instruments, and so forth. In particular, the present electric storage apparatus is usable suitably for driving the motors of electric automobiles and hybrid automobiles requiring large capacities and large outputs.

1-7. (canceled)

8. A negative-electrode active material comprising a mixed powder including:
a first active-material powder composed of a granular graphite particle; and
a second active-material powder composed of a plate-shaped graphite particle having a thickness of from 0.3 nm to 100 nm and a major-axis-direction length of from 0.1 μm to 500 μm;
wherein, onto a surface of said plate-shaped graphite particle, an aromatic vinyl copolymer is adsorbed, the aromatic vinyl copolymer containing a vinyl aromatic monomer unit expressed by following formula (1):
—(CH₂—CHX)— (1)
(in formula (1), “X” represents a phenyl group, a naphtyl group, an anthracenyl group or a pyrenyl group, wherein the groups are also allowed to have a substituent group).

9. The negative-electrode active material as set forth in claim 8, wherein said second active-material powder is included in an amount of from 10 to 90% by mass when a sum of said first active-material powder and said second active-material power is taken as 100% by mass.

10. The negative-electrode active material as set forth in claim 9, wherein said second active-material powder is included in an amount of from 30 to 70% by mass when a sum of said first active-material powder and said second active-material power is taken as 100% by mass.

11. An electric storage apparatus having a negative electrode comprising:
a current collector; and
a negative-electrode active-material layer arranged on a surface of the current collector, and including the negative-electrode active material as set forth in claim 8.

12. The electric storage apparatus as set forth in claim 11, wherein, in said negative-electrode active-material layer, a plurality of said plate-shaped graphite particles are included, at least some of the plate-shaped graphite particles having a plate face crossing with respect to a surface of said current collector.

13. An electric storage apparatus having a negative electrode comprising:
a current collector; and
a negative-electrode active-material layer arranged on a surface of the current collector, and including a negative-electrode active material comprising a mixed powder including:
a first active-material powder composed of a granular graphite particle; and
a second active-material powder composed of a plate-shaped graphite particle having a thickness of from 0.3 nm to 100 nm and a major-axis-direction length of from 0.1 μm to 500 μm;
wherein, in said negative-electrode active-material layer, a plurality of said plate-shaped graphite particles are included, at least some of the plate-shaped graphite particles having a plate face crossing with respect to a surface of said current collector.

14. The electric storage apparatus as set forth in claim 11 making a lithium-ion secondary battery.

15. The electric storage apparatus as set forth in claim 13 making a lithium-ion secondary battery.
